(19) United States
(12) Patent Application Publication
(10) Pub. No.: US 2024/0364128 A1
(43) Pub. Date: Oct. 31, 2024

(54) CONFIGURABLE RESISTOR BANK FOR BATTERY MANAGER

(71) Applicant: Caterpillar Inc., Peoria, IL (US)

(72) Inventors: Saurav ROY CHOUDHURY, Bengaluru (IN); Andrew Jason PEPLINSKI, Peoria, IL (US)

(73) Assignee: Caterpillar Inc., Peoria, IL (US)

(21) Appl. No.: 18/307,997

(22) Filed: Apr. 27, 2023

(51) Int. Cl. H02J 7/00

(52) U.S. Cl. CPC H02J 7/007182; H02J 7/0013; H02J 7/0047

(57) ABSTRACT

In some implementations, a battery manager may identify a first voltage rating of a first battery pack. The battery manager may configure, based on the first voltage rating, a resistor bank of the battery manager to have a first resistance value. The battery manager may perform, via the resistor bank having the first resistance value, a first discharge operation, associated with the first battery pack, having a first duration. The battery manager may identify a second voltage rating of a second battery pack. The battery manager may configure, based on the second voltage rating, the resistor bank of the battery manager to have a second resistance value. The battery manager may perform, via the resistor bank having the second resistance value, a second discharge operation, associated with the second battery pack, having a second duration, and a difference between the first duration and the second duration satisfying a time threshold.

### TECHNICAL FIELD

The present disclosure relates generally to batteries and, for example, to a configurable resistor bank for a battery manager.

### BACKGROUND

A machine may include one or more battery packs to provide power to components of the machine, such as lights, computer systems, and/or a motor, among other examples. In some cases, a battery and/or battery pack may be stored for extended periods of time when not in use (e.g., when stored in a warehouse). In such examples, a battery manager can be used to charge and/or discharge the battery and/or the battery pack to a desired state of charge (SoC) for storage. For example, the desired SoC may be an SoC that ensures optimal battery health and longevity during storage of the battery and/or the battery pack. As an example, if the battery and/or the battery pack is stored with too high of an SoC, then the battery and/or the battery pack may experience overcharging and damage to the battery and/or the battery pack. If the battery and/or the battery pack is stored with too low of an SoC, then the battery and/or the battery pack may experience reduced capacity and/or a reduced lifespan.

In some examples, the battery manager discharges a battery and/or a battery pack (e.g., to the desired SoC) via a resistor bank. The resistor bank includes one or more resistors and may be used to discharge the battery and/or the battery pack in a controlled and safe manner (e.g., by providing a load for the battery and/or the battery pack, causing the battery and/or the battery pack to discharge at a controlled rate). A resistance of the resistor bank may have a fixed value. Therefore, an amount of time associated with discharging the battery and/or the battery pack may depend on a voltage (e.g., a voltage rating) of the battery and/or the battery pack. For example, the time associated with discharging the battery and/or the battery pack is proportional to the capacity of the battery and/or the battery pack and the resistance of the resistor bank, and inversely proportional to the voltage of the battery and/or the battery pack. The lower the voltage of the battery and/or the battery pack, the longer the battery and/or the battery pack will take to discharge. As an example, a battery pack having a voltage of 300 volts may take four times as long to discharge as a battery pack having a voltage of 600 volts (e.g., via the battery manager and the resistor bank having the same resistance value for both discharge operations).

As a result, batteries and/or battery packs having different voltages may take vastly different amounts of time to discharge via the battery manager. This increases a difficulty of an operator maintaining a desired SoC for the batteries and/or battery packs having different voltages. Further, this may result in the need for multiple battery managers (e.g., having resistor banks with different resistance values) to be used to discharge different batteries and/or battery packs having different voltages (e.g., to ensure the same or similar discharge times for the different batteries and/or battery packs). This increases a cost and complexity associated with maintaining a desired SoC for the batteries and/or battery packs because multiple battery managers are needed to discharge different batteries and/or battery packs (e.g., having different voltages) in the same or similar amount of time.

Patent Cooperation Treaty (PCT) patent application No. WO2017092521A1 (the '521 application) discloses a battery pack and a battery management device. The circuit for performing voltage balance control on the battery pack includes a storage battery pack, a main controller, a battery voltage measuring circuit and a battery pack voltage balancing circuit. The battery voltage measuring circuit measures a voltage of each of the storage batteries and outputs measured voltage signals to the main controller. The main controller compares the voltage signals and when a difference between two voltage signal values is greater than a preset reference value, outputs a balance control signal to the battery pack voltage balancing circuit. The battery pack voltage balancing circuit is connected to the storage battery pack and the main controller respectively, and performs charge balance or discharge balance according to the balance control signal on the storage battery in the storage battery packs requiring the charge balance or discharge balance.

However, the '521 application does not disclose a battery manager for charging and/or discharging a battery and/or a battery pack to a desired SoC. The '521 application does not disclose a manner to handle a difference in durations of discharge operations of different battery packs having different voltage ratings. The battery manager of the present disclosure solves one or more of the problems set forth above and/or other problems in the art.

### SUMMARY

A battery manager may include a configurable resistor bank that is configurable to have a set of resistance values, and a controller configured to: detect a first voltage of a first battery pack having a connection with the battery manager; select a first resistance value, from the set of resistance values, based on the first voltage of the first battery pack and based on a battery pack discharge time; configure the configurable resistor bank to have the first resistance value; and perform a first discharge operation associated with discharging the first battery pack via the configurable resistor bank having the first resistance value.

A method performed by a battery manager may include identifying a first voltage rating of a first battery pack; configuring, based on the first voltage rating, a resistor bank of the battery manager to have a first resistance value; performing, via the resistor bank configured to have the first resistance value, a first discharge operation associated with the first battery pack, the first discharge operation having a first duration; identifying a second voltage rating of a second battery pack; configuring, based on the second voltage rating, the resistor bank of the battery manager to have a second resistance value; and performing, via the resistor bank configured to have the second resistance value, a second discharge operation associated with the second battery pack, the second discharge operation having a second duration, and a difference between the first duration and the second duration satisfying a time threshold.

A battery manager may include a resistor bank including a set of resistors and one or more electrical contacts, the resistor bank being configurable to have multiple resistance values; one or more memories; and one or more processors configured to: identify a first voltage rating of a first battery pack that is electrically connected to the battery manager; cause, based on the first voltage rating, the one or more electrical contacts to be configured to cause the resistor bank to have a first resistance value; perform, via the resistor bank configured to have the first resistance value, a first discharge operation to discharge the first battery pack to a state of charge (SoC), the first discharge operation having a first duration; identify a second voltage rating of a second battery pack that is electrically connected to the battery manager; cause, based on the second voltage rating, the one or more electrical contacts to be configured to cause the resistor bank to have a second resistance value; and perform, via the resistor bank configured to have the second resistance value, a second discharge operation to discharge the second battery pack to the SoC, the second discharge operation having a second duration, and a difference between the first duration and the second duration satisfying a time threshold.

### BRIEF DESCRIPTION OF THE DRAWINGS

FIG. 1 is a diagram of an example battery pack described herein.

FIG. 2 is a diagram of an example electrical connection between a battery pack and a battery manager described herein.

FIG. 3 is a diagram of an example of a configurable resistor bank for a battery manager described herein.

FIG. 4 is a flowchart of an example process associated with the configurable resistor bank for the battery manager described herein.

### DETAILED DESCRIPTION

This disclosure relates to a battery manager associated with a battery pack and/or a battery, and is applicable to any machine application that uses power provided by a battery. As used herein, “battery cell,” “battery,” and “cell” may be used interchangeably. As used herein, “machine” may refer to any machine that performs an operation associated with an industry, such as mining, construction, farming, transportation, or any other industry. For example, a machine may be an electric vehicle, a hybrid vehicle, a compactor machine, a paving machine, a cold planer, a grading machine, a backhoe loader, a wheel loader, a harvester, an excavator, a motor grader, a skid steer loader, a tractor, and/or a dozer, among other examples. Additionally, or alternatively, the battery pack and/or the battery described herein may be used in an energy storage application, such as for solar energy storage and/or wind energy storage, among other examples.

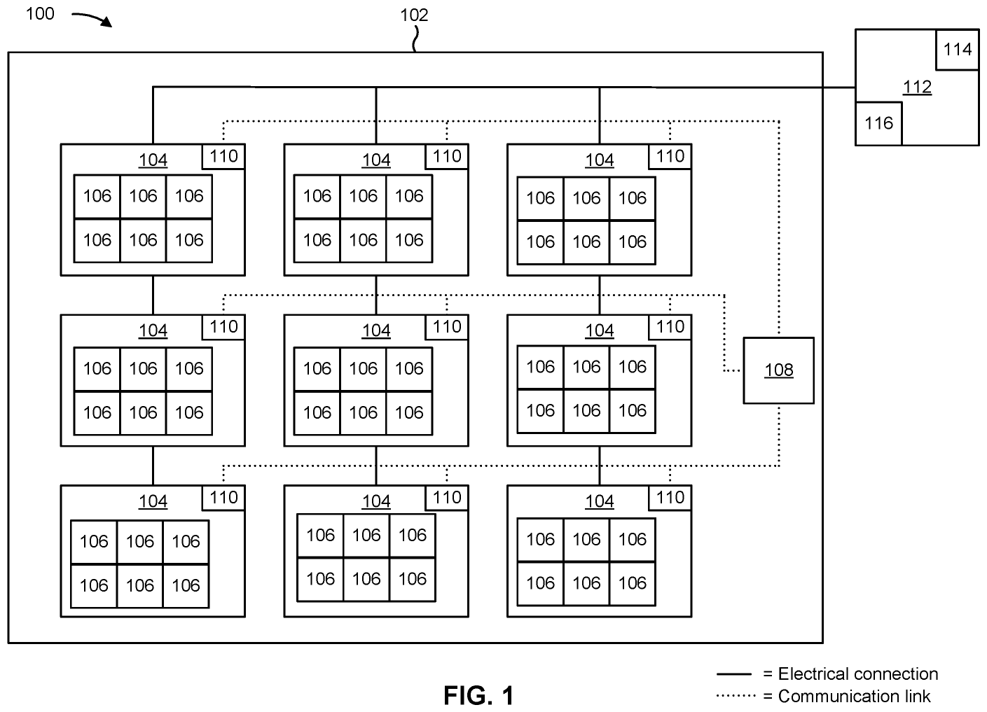

FIG. 1 is a diagram of an example battery pack 100 described herein. The battery pack 100 may include a battery pack housing 102, one or more battery modules 104, and one or more battery cells 106. The battery pack 100 includes a battery pack controller 108 associated with storing information and/or controlling one or more operations associated with the battery pack 100. Each battery module 104 includes a module controller 110 associated with storing information and/or controlling one or more operations associated with the battery module 104.

The battery pack housing 102 may include metal shielding (e.g., steel, aluminum, and/or the like) to protect elements (e.g., battery modules 104, battery cells 106, the battery pack controller 108, the module controllers 110, wires, circuit boards, cooling systems, and/or the like) positioned within battery pack housing 102. Each battery module 104 includes one or more battery cells 106. The battery cells can be connected in series and/or in parallel within the battery module 104 (e.g., via terminal-to-busbar welds). Each battery cell 106 is associated with a chemistry type. The chemistry types may include lithium (Li-ion), nickel-metal hydride (NiMH), nickel cadmium (NiCd), lithium ion polymer (Li-ion polymer), lithium iron phosphate (LFP), and/or nickel manganese cobalt (NMC), among other examples. The battery modules 104 are connected via electrical connections, as shown in FIG. 1.

The battery pack 100 may be associated with a battery manager 112. The battery manager 112 may also be referred to as a battery maintainer or a trickle charger (or trickle discharger), among other examples. The battery manager 112 may be associated with maintaining a state of charge (SoC) of the battery pack 100. While operations are described herein in connection with the battery pack 100, the battery manager 112 may similarly maintain the SoC of one or more battery modules 104 and/or one or more battery cells 106. The battery manager 112 may perform a charging operation and/or a discharging operation of the battery pack 100 to maintain a given SoC of the battery pack 100 (e.g., to ensure an optimal health and/or increased lifespan of the battery pack 100 when the battery pack 100 is stored and/or not in use with a machine). The charging and discharging operations of the battery manager 112 are designed to ensure that the battery pack 100 is in good condition and ready for use when needed.

The “SoC” of the battery pack 100 refers to the percentage of a total capacity of the battery pack 100 that is currently available for use. The SoC is a measure of the current charge level of the battery pack 100, expressed as a percentage of a maximum charge capacity of the battery pack 100. The battery manager 112 can be used to maintain a given (or desired) SoC for the battery pack 100 while the battery pack 100 is stored and/or not in use. The SoC of a battery during storage depends on the type of battery (e.g., a chemistry type of the battery cells 106) and the length of time that the battery pack 100 will be stored. For example, the SoC for storage for some battery packs 100 is between 50% and 75%.

The battery manager 112 includes a controller 114. The controller 114 is communicatively connected (e.g., via a communication link) to the battery pack controller 108 and/or to one or more module controllers 110. The controller 114 may be associated with receiving, generating, storing, processing, providing, and/or routing information associated with the battery manager 112. The controller 114 may also be referred to as a battery manager management device or system. The controller 114 control and/or operate a resistor bank 116 of the battery manager 112. For example, the controller 114 is configured to cause one or more electrical contacts (e.g., switches and/or relays) included in the resistor bank 116 to flip and/or switch to produce a given resistance value of the resistor bank 116, as described in more detail elsewhere herein.

The controller 114 includes one or more processors and/or one or more memories. A processor may include a central processing unit, a graphics processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. In some implementations, the processor may include one or more processors capable of being programmed to perform one or more operations or processes described elsewhere herein. The memory may include volatile and/or nonvolatile memory. For example, the memory may include random access memory (RAM), read only memory (ROM), and/or another type of memory (e.g., a flash memory, a magnetic memory, and/or an optical memory). The memory may include internal memory (e.g., RAM, ROM, or a hard disk drive) and/or removable memory (e.g., removable via a universal serial bus connection). The memory may be a non-transitory computer-readable medium. The memory may store information, one or more instructions, and/or software (e.g., one or more software applications) related to the operation of the battery manager 112. The memory may include one or more memories that are coupled (e.g., communicatively coupled) to the processor, such as via a bus. Communicative coupling between a processor and a memory may enable the processor to read and/or process information stored in the memory and/or to store information in the memory.

The battery pack controller 108 is communicatively connected (e.g., via a communication link) to each module controller 110. The battery pack controller 108 may be associated with receiving, generating, storing, processing, providing, and/or routing information associated with the battery pack 100. The battery pack controller 108 may also be referred to as a battery pack management device or system. The battery pack controller 108 may communicate with the battery manager 112 and/or the controller 114, control a start-up and/or shut-down procedure of the battery pack 100, monitor a string (e.g., of battery modules 104) current and/or voltage, and/or monitor and/or control a current and/or voltage provided by the battery pack 100, among other examples. The battery pack controller 108 includes one or more processors and/or one or more memories in a similar manner as described above in connection with the controller 114.

A module controller 110 includes a cell monitoring board associated with reporting, to the battery pack controller 108, one or more parameters associated with battery cells 106 included in a given battery module 104. The module controller 110 may include one or more processors and/or one or more memories (e.g., in a similar manner as described above in connection with the controller 114).

As indicated above, FIG. 1 is provided as an example. Other examples may differ from what is described with regard to FIG. 1.

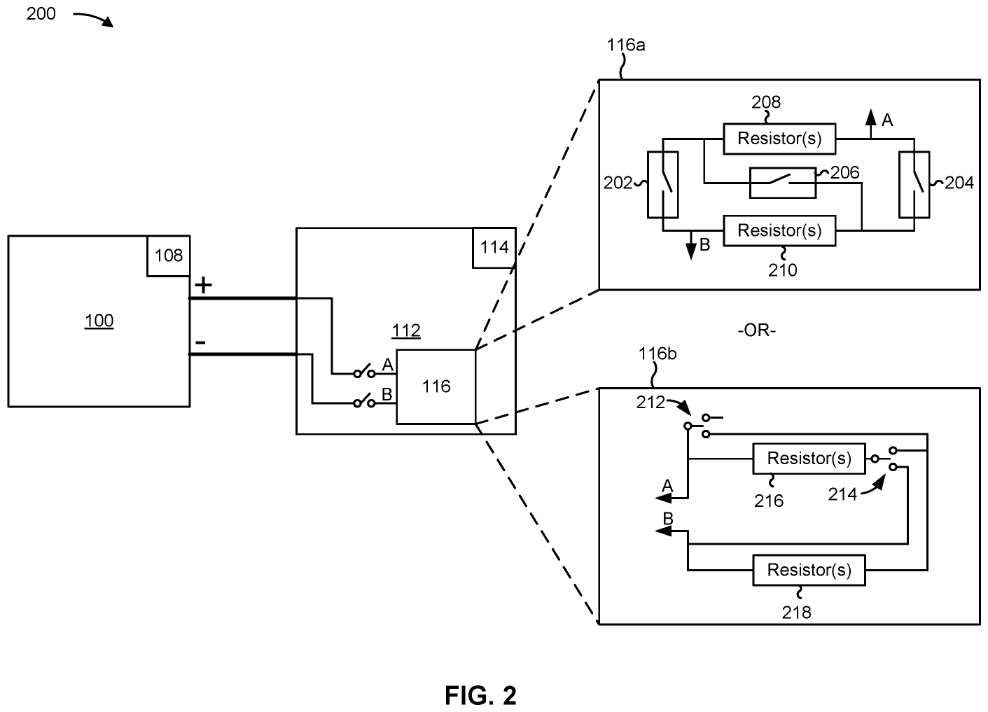

FIG. 2 is a diagram of an example electrical connection between a battery pack 100 and a battery manager 112 described herein. For example, the battery pack 100 and the battery manager may be electrically coupled or connected via a cable. The cable may have two connectors, one connector that connects to the battery pack 100 and another connector that connects to the battery manager 112. For example, a positive terminal of the battery pack 100 may be connected to a positive terminal of the battery manager 112 and a negative terminal of the battery pack 100 may be connected to a negative terminal of the battery manager 112 via the cable. The electrical connection (e.g., via the cable) enables electrical current to flow from the battery manager 112 to the battery pack 100 to charge and/or discharge the battery pack 100.

As shown in FIG. 2, an electrical circuit of the battery manager 112 (e.g., associated with charging and/or discharging the battery pack 100) may include the resistor bank 116. The resistor bank 116 includes one or more resistors and one or more electrical contacts (e.g., one or more switches, one or more relays, and/or one or more other types of electrical contacts). The resistors included in the resistor bank 116 may be connected in series and/or in parallel. The resistor bank 116 is a configurable resistor bank. The resistor bank 116 may be configurable to have multiple (e.g., different) resistance values (e.g., based on a configuration of the one or more electrical contacts). For example, the resistor bank 116 may be configurable to produce multiple, different, resistance values. The resistor bank 116 may be configurable to regulate the flow of electric current to the battery pack 100 (e.g., depending on the voltage rating of the battery pack 100).

The resistor bank 116 is configurable to produce two or more resistance values. The resistor bank 116 may have any suitable configuration (e.g., of the one or more resistors and the one or more electrical contacts) to enable the resistor bank to produce the two or more resistance values. For example, the resistor bank 116 may include two or more resistors (or two or more sets of resistors) connected in series and/or in parallel, and the one or more electrical contacts may be placed within an electrical circuit of the resistor bank 116 to enable the resistance produced by the resistor bank 116 to include the two or more resistance values. The one or more electrical contacts may include one or more single pole, single throw (SPST) electrical contacts and/or one or more single pole, double throw (SPDT) electrical contacts, among other examples.

One example of the resistor bank 116 is a resistor bank 116a shown in FIG. 2. The resistor bank 116a may be configurable to produce two resistance values and may include three SPST electrical contacts. For example, the resistor bank 116a includes an electrical contact 202, an electrical contact 204, and an electrical contact 206. The resistor bank 116a includes one or more resistors 208 (e.g., having a resistance of R₁) and one or more resistors 210 (e.g., having a resistance of R₂). By controlling a configuration of the electrical contact 202, the electrical contact 204, and/or the electrical contact 206, the resistor bank 116a is configurable to produce different resistance values, such as R₁+R₂ (e.g., if the electrical contact 202 and the electrical contact 204 are in an open position and the electrical contact 206 is in a closed position, thereby connecting the one or more resistors 208 and the one or more resistors 210 in series) or

$$\frac{1}{( \frac{1}{{R}_{1}} + \frac{1}{{R}_{2}} )}$$

(e.g., if the electrical contact 202 and the electrical contact 204 are in a closed position and the electrical contact 206 is in an open position, thereby connecting the one or more resistors 208 and the one or more resistors 210 in parallel).

Another example of the resistor bank 116 is a resistor bank 116b shown in FIG. 2. The resistor bank 116b may be configurable to produce two resistance values and may include two SPDT electrical contacts. For example, the resistor bank 116b includes an electrical contact 212, and an electrical contact 214. The resistor bank 116b includes one or more resistors 216 (e.g., having a resistance of R₃) and one or more resistors 218 (e.g., having a resistance of R₄). By controlling a configuration of the electrical contact 212 and the electrical contact 214, the resistor bank 116b is configurable to produce different resistance values, such as R₃+R₄ (e.g., if the electrical contact 212 and the electrical contact 214 are in an upper position, thereby connecting the one or more resistors 216 and the one or more resistors 218 in series) or

$$\frac{1}{( \frac{1}{{R}_{3}} + \frac{1}{{R}_{4}} )}$$

(e.g., if the electrical contact 212 and the electrical contact 214 are in a lower position, thereby connecting the one or more resistors 216 and the one or more resistors 218 in parallel). The resistor bank 116a and the resistor bank 116b are provided as examples, and the resistor bank 116 may be configurable to produce or have any number of resistance values in any suitable manner (e.g., via two or more resistors connected in series and/or in parallel or with any number of electrical contacts).

The controller 114 may provide a command to the resistor bank 116 to cause the one or more electrical contacts to be configured to produce a given resistance value (e.g., from the multiple resistance values that the resistor bank 116 is capable of producing). For example, as described in more detail elsewhere herein, the controller 114 may configure the resistor bank 116 to have a resistance value that is selected based on a voltage (or a voltage rating) of the battery pack 100.

As indicated above, FIG. 2 is provided as an example. Other examples may differ from what is described with regard to FIG. 2.

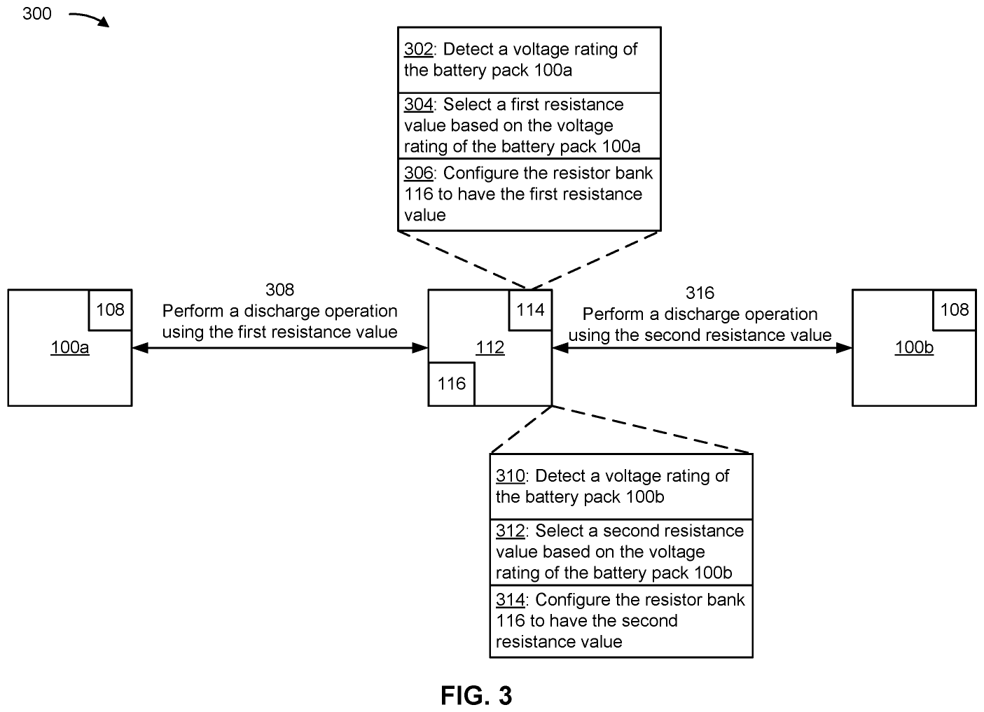

FIG. 3 is a diagram of an example of a configurable resistor bank 116 for a battery manager 112 described herein. As shown in FIG. 3, the battery manager 112 is configured to connect (e.g., via an electrical connection) with a first battery pack 100a and a second battery pack 100b. The first battery pack 100a is associated with a first voltage (e.g., a first voltage rating) and the second battery pack 100b is associated with a second voltage (e.g., a second voltage rating). The first voltage and the second voltage are different voltages. The voltage rating (also referred to herein as simply “voltage”) of a battery pack 100 is a voltage output that the battery pack 100 is configured to produce. The voltage rating differs from a capacity of the battery pack 100 (e.g., the capacity, which may be measured in ampere-hours, is an indication of how long the battery pack 100 can provide power at the voltage output of the battery pack 100).

At a first time, the battery manager 112 establishes a connection (e.g., an electrical connection) with the first battery pack 100a. As shown by reference number 302, the controller 114 detects a voltage rating (e.g., the first voltage or the first voltage rating) of the first battery pack 100a. The controller 114 may detect the voltage rating of the first battery pack 100a based on communicating with the battery pack controller 108 of the first battery pack 100a. For example, the battery pack controller 108 provides, and the controller 114 obtains, an indication of the voltage rating (e.g., the first voltage or the first voltage rating) of the first battery pack 100a. As another example, the controller 114 obtains an operator input (e.g., from an operator via a user interface or control board of the battery manager 112) indicating the voltage rating (e.g., the first voltage or the first voltage rating) of the first battery pack 100a. As another example, the controller 114 performs a measurement of the first battery pack 100a (e.g., a voltage measurement). The measurement may indicate the voltage rating (e.g., the first voltage or the first voltage rating) of the first battery pack 100a.

As shown by reference number 304, the controller 114 selects a first resistance value, from a set of resistance values associated with the resistor bank 116, based on the voltage rating of the first battery pack 100a. As described elsewhere herein, the resistor bank 116 is configurable to have or produce the set of resistance values (e.g., via two or more resistors and one or more electrical contacts). The controller 114 may select the first resistance value based on the voltage rating of the first battery pack 100a and a battery pack discharge time. The battery pack discharge time is an intended duration of discharge operations (e.g., to a desired SoC) for battery packs 100 (e.g., having different voltage ratings). In other words, the controller 114 selects the first resistance value to cause a discharge operation of the first battery pack 100a to have a duration of, or similar to, the battery pack discharge time.

For example, a duration of the discharge operation for a battery pack 100 is proportional to the resistance value of the resistor bank 116 and inversely proportional to the voltage rating of the battery pack 100. The duration of a discharge operation may be estimated as

$${T}_{d i s c h a r g e} = \frac{c * ( S o {C}_{i} - S o {C}_{f} )}{{P}_{d i s c h a r g e}} ,$$

where T_{discharge} is the duration of the discharge operation, C is the capacity of the battery pack 100, SoCᵢ is an initial SoC of the battery pack 100 (e.g., before the discharge operation), SoC_{f} is a final SoC of the battery pack 100 (e.g., after the discharge operation), and P_{discharge} is a power of the discharge operation (e.g., a power provided to the battery pack 100 by the battery manager 112). An amount of discharge with respect to an SoC of a battery pack is SoCᵢ-SoC_{f}. According to Ohm's Law, the power of the discharge operation may be represented as

$${P}_{d i s c h a r g e} = \frac{{V}_{Batt}^{2}}{R} ,$$

where V_{Butt} is the voltage rating of the battery pack 100 and R is the resistance value of the resistor bank 116. The controller 114 selects the first resistance value, for the first discharge operation, such that respective durations of the discharge operation of the first battery pack 100a (e.g., having the first voltage rating) and a discharge operation of the second battery pack 100b (e.g., having the second voltage rating and associated with a second resistance value, as described below) are approximately the same (e.g., assuming that all other variables, such as a change in the SoC (e.g., SoCᵢ−SoC_{f}), C, SoCᵢ, and SoC_{f}, are equal). In other words, as long as C*(SoCᵢ−SoC_{f}) is the same for the first battery pack 100a and the second battery pack 100b, the controller 114 can select configurable resistance values to ensure that the discharge times of the first battery pack 100a and the second battery pack 100b approximately the same. In some implementations, the controller 114 selects the first resistance value to result in a given power of the discharge operation (e.g., a given P_{discharge}). In other words, the controller 114 selects the first resistance value such that the discharge operation of the first battery pack 100a is associated with a discharge power that is approximately the same for discharge operations with battery packs 100 having different voltage ratings (e.g., such that a discharge power is approximately the same for discharge operations associated with battery packs 100 having different voltage ratings). As used herein, two values may be “approximately” or “substantially” the same if a difference between the two values satisfies a threshold. A first value may be “substantially” a second value if a difference between the first value and the second value satisfies a threshold (e.g., the threshold may be 1%, 5%, 10%, or another value). A first value may be “substantially” a second value if the first value is within a tolerance the second value.

The controller 114 may select the first resistance value based on a mapping. The controller 114 may store the mapping. The mapping may indicate or define resistance values, from the multiple resistance values associated with the resistor bank 116, associated with respective voltage ratings. For example, the mapping may indicate one-to-one mappings of resistance values to voltage ratings. The mappings may be determined to cause discharge operations for battery packs having different voltage ratings to take approximately the same amount of time (e.g., assuming that all other variables, such as C, SoCᵢ, and SoC_{f}, between the battery packs are equal). For example, the controller 114 may use the detected voltage rating of the first battery pack 100a to search the mapping to identify the first resistance value. The mapping indicates that the voltage rating of the first battery pack 100a is associated with, or mapped to, the first resistance value. As another example, the controller 114 may calculate or determine the first resistance value based on the detected voltage rating of the first battery pack 100a (e.g., using the equation(s) described above to result in a given battery pack discharge time or T_{discharge}).

As shown by reference number 306, the controller 114 configures the resistor bank 116 to have the first resistance value. The controller 114 provides a command to the one or more electrical contacts of the resistor bank 116 to cause the one or more electrical contacts to be configured to cause an electrical circuit of the resistor bank 116 to have or produce the first resistance value. As shown by reference number 308, the controller 114 may cause a discharge operation to be performed with the first battery pack 100a (e.g., via the resistor bank configured to have or produce the first resistance value). For example, the battery manager 112 may provide a load across the terminals of the first battery pack 100a to cause power to be drawn from the first battery pack 100a (e.g., via the resistor bank 116). The selected resistance value (e.g., the first resistance value) of the resistor bank 116 enables a controlled and predictable discharging of the first battery pack 100a. The battery manager 112 may discharge the first battery pack 100a to a given SoC. The discharge operation associated with the first battery pack 100a may be associated with a first duration (e.g., may take a first amount of time).

At a second time (e.g., before or after the first time at which the battery manager 112 is connected to the first battery pack 100a), the battery manager 112 establishes a connection (e.g., an electrical connection) with the second battery pack 100b. As shown by reference number 310, the controller 114 detects a voltage rating (e.g., the second voltage or the second voltage rating) of the second battery pack 100b. The controller 114 may detect the voltage rating of the second battery pack 100b based on communicating with the battery pack controller 108 of the first battery pack 100a, in a similar manner as described above. As another example, the controller 114 obtains an operator input (e.g., from an operator via a user interface or control board of the battery manager 112) indicating the voltage rating, or performs a measurement of the first battery pack 100a (e.g., a voltage measurement) to detect the voltage rating (e.g., the second voltage or the second voltage rating) of the second battery pack 100b.

As shown by reference number 312, the controller 114 selects a second resistance value, from the set of resistance values associated with the resistor bank 116, based on the voltage rating of the second battery pack 100b. The second resistance value may be different than the first resistance value. The controller 114 may select the second resistance value based on the voltage rating of the second battery pack 100b and the battery pack discharge time, in a similar manner as described above. In other words, the controller 114 selects the second resistance value to cause a discharge operation of the second battery pack 100b to have a duration of, or similar to, the battery pack discharge time and/or a duration of the discharge operation associated with the first battery pack 100a.

The controller 114 selects the second resistance value, for the second discharge operation, such that a duration of the second discharge operation of the second battery pack 100b (e.g., having the second voltage rating) and a duration of a discharge operation of the first battery pack 100a (e.g., having the first voltage rating) are approximately the same (e.g., assuming that all other variables, such as C, SoCᵢ, and SoC_{f}, are equal between the discharge operations). In some implementations, the controller 114 selects the second resistance value to result in the given power of the discharge operation (e.g., the given P_{discharge}) described above. The controller 114 may select the second resistance value based on the mapping in a similar manner as described above. The controller 114 may calculate or determine the second resistance value based on the detected voltage rating of the second battery pack 100b (e.g., using the equation(s) described above to result in the given battery pack discharge time or T_{discharge}).

As shown by reference number 314, the controller 114 configures the resistor bank 116 to have the second resistance value. The controller 114 provides a command to the one or more electrical contacts of the resistor bank 116 to cause the one or more electrical contacts to be configured to cause an electrical circuit of the resistor bank 116 to have or produce the second resistance value. As shown by reference number 316, the controller 114 may cause a discharge operation to be performed with the second battery pack 100b (e.g., via the resistor bank configured to have or produce the second resistance value). For example, the battery manager 112 may provide a load across the terminals of the second battery pack 100b to cause power to be drawn from the second battery pack 100b (e.g., via the resistor bank 116). The selected resistance value (e.g., the second resistance value) of the resistor bank 116 enables a controlled and predictable discharging of the second battery pack 100b. The battery manager 112 may discharge the second battery pack 100b to a given SoC (e.g., which may be the same as the given SoC to which the first battery pack 100a is discharged). The discharge operation associated with the second battery pack 100b may be associated with a second duration (e.g., may take a first amount of time).

A difference between the first duration of the first discharge operation (e.g., associated with the first battery pack 100a) and the second duration of the second discharge operation (e.g., associated with the second battery pack 100b) may satisfy a threshold (e.g., may be less than or equal to the threshold). For example, the first duration and the second duration may be approximately the same (e.g., even though the first battery pack 100a and the second battery pack 100b are associated with different voltage ratings). Although examples have been described herein in connection with discharging operations, the configurable resistor bank 116 may be similarly used for charging operations for battery packs 100 having different voltage ratings.

As indicated above, FIG. 3 is provided as an example. Other examples may differ from what is described with regard to FIG. 3.

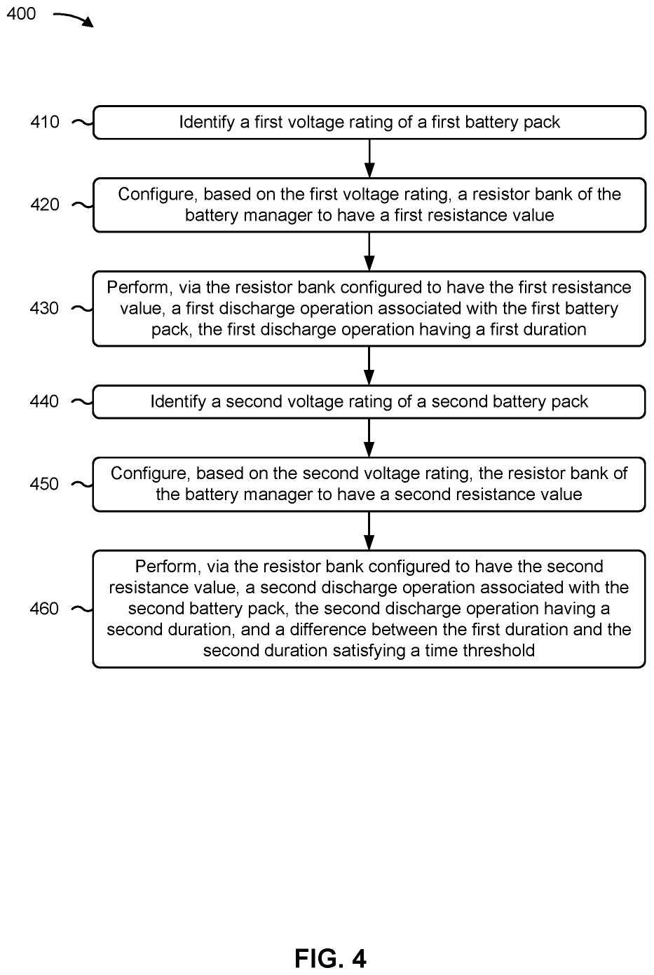

FIG. 4 is a flowchart of an example process 400 associated with a configurable resistor bank for a battery manager described herein. One or more process blocks of FIG. 4 may be performed by a battery manager (e.g., the battery manager 112 and/or the controller 114). Additionally, or alternatively, one or more process blocks of FIG. 4 may be performed by another device or a group of devices separate from or including the battery manager, such as another device or component that is internal or external to the battery manager.

As shown in FIG. 4, process 400 may include identifying a first voltage rating of a first battery pack (block 410). For example, the battery manager may identify a first voltage rating of a first battery pack, as described above. Identifying the first voltage rating of the first battery pack may include obtaining, from a first controller of the first battery pack, (e.g., a battery pack controller 108) an indication of the first voltage rating.

As further shown in FIG. 4, process 400 may include configuring, based on the first voltage rating, a resistor bank of the battery manager to have a first resistance value (block 420). For example, the battery manager may configure, based on the first voltage rating, a resistor bank of the battery manager to have a first resistance value, as described above. The resistor bank may be capable of being configured to have multiple resistance values including the first resistance value and a second resistance value.

As further shown in FIG. 4, process 400 may include performing, via the resistor bank configured to have the first resistance value, a first discharge operation associated with the first battery pack, the first discharge operation having a first duration (block 430). For example, the battery manager may perform, via the resistor bank configured to have the first resistance value, a first discharge operation associated with the first battery pack, the first discharge operation having a first duration, as described above.

As further shown in FIG. 4, process 400 may include identifying a second voltage rating of a second battery pack (block 440). For example, the battery manager may identify a second voltage rating of a second battery pack, as described above. Identifying the second voltage rating of the second battery pack may include obtaining, from a second controller of the second battery pack (e.g., a battery pack controller 108), an indication of the second voltage rating.

As further shown in FIG. 4, process 400 may include configuring, based on the second voltage rating, the resistor bank of the battery manager to have a second resistance value (block 450). For example, the battery manager may configure, based on the second voltage rating, the resistor bank of the battery manager to have a second resistance value, as described above.

As further shown in FIG. 4, process 400 may include performing, via the resistor bank configured to have the second resistance value, a second discharge operation associated with the second battery pack, the second discharge operation having a second duration, and a difference between the first duration and the second duration satisfying a time threshold (block 460). For example, the battery manager may perform, via the resistor bank configured to have the second resistance value, a second discharge operation associated with the second battery pack, the second discharge operation having a second duration, and a difference between the first duration and the second duration satisfying a time threshold, as described above. The first discharge operation and the second discharge operation may be associated with maintaining states of charge of respective battery packs from the first battery pack and the second battery pack.

The first discharge operation may be associated with using a first set of one or more resistors from the resistor bank, and the second discharge operation may be associated with using a second set of one or more resistors from the resistor bank. The first discharge operation and the second discharge operation may be associated with discharging the first battery pack and the second battery pack, respectively, a same amount with respect to an SoC of the first battery pack and the second battery pack.

In some implementations, a mapping defines resistance values, from the multiple resistance values, associated with respective voltage ratings, and process 400 includes selecting the first resistance value to be associated with the first discharge operation based on the first voltage rating and the mapping, and selecting the second resistance value to be associated with the second discharge operation based on the second voltage rating and the mapping.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

In some examples, the battery manager discharges a battery and/or a battery pack (e.g., to the desired SoC) via a resistor bank. The resistor bank includes one or more resistors and may be used to discharge the battery and/or the battery pack in a controlled and safe manner (e.g., by providing a load for the battery and/or the battery pack, causing the battery and/or the battery pack to discharge at a controlled rate). A resistance of the resistor bank is a fixed value.

Therefore, an amount of time associated with discharging the battery and/or the battery pack may depend on a voltage (e.g., a voltage rating) of the battery and/or the battery pack. As a result, batteries and/or battery packs having different voltages may take vastly different amounts of time to discharge via the battery manager. This increases a difficulty of an operator maintaining a desired SoC for the batteries and/or battery packs having different voltages. Further, this may result in the need for multiple battery managers (e.g., having resistor banks with different resistance values) to be used to discharge different batteries and/or battery packs having different voltages.

Some implementations described herein enable a battery manager 112 having a configurable resistor bank 116 to enable discharge operations for battery packs 100 having different voltage ratings to take approximately the same amount of time (e.g., assuming that a capacity and an amount of charge to be discharged is approximately equal between the battery packs 100). For example, a controller 114 of the battery manager 112 may cause the configurable resistor bank 116 (e.g., that is used for discharging battery packs 100) to have different resistance values depending on the voltage rating of a battery pack 100 being discharged.

As a result, a discharging power for the battery packs 100 having different voltage ratings may be approximately the same, resulting in a duration of the discharging operations for the battery packs 100 being approximately the same. This reduces a complexity for an operator maintaining a desired SoC for the battery packs having different voltage ratings. Further, this enables a single battery manager 112 to be used to discharge battery packs 100 having different voltage ratings in approximately the same time, eliminating the need for different battery managers 112 to be used with battery packs 100 having different voltage ratings. This conserves a cost that would have otherwise been associated with purchasing and/or maintaining multiple battery managers 112. Additionally, the reduces a complexity and/or an amount of time for discharging operations that would have otherwise been associated with using and/or switching between different battery managers 112 for discharging battery packs 100 having different voltage ratings.

What is claimed is:

1. A battery manager, comprising:
a configurable resistor bank that is configurable to have a set of resistance values; and
a controller configured to:
detect a first voltage of a first battery pack having a connection with the battery manager;
select a first resistance value, from the set of resistance values, based on the first voltage of the first battery pack and based on a battery pack discharge time;
configure the configurable resistor bank to have the first resistance value; and
perform a first discharge operation associated with discharging the first battery pack via the configurable resistor bank having the first resistance value.

2. The battery manager of claim 1, wherein the controller is further configured to:
detect a second voltage of a second battery pack having a connection with the battery manager;
select a second resistance value, from the set of resistance values, based on the second voltage of the second battery pack and based on the battery pack discharge time;
configure the configurable resistor bank to have the second resistance value; and
perform a second discharge operation associated with discharging the second battery pack via the configurable resistor bank having the second resistance value.

3. The battery manager of claim 2, wherein the first discharge operation and the second discharge operation have respective durations that are both substantially the battery pack discharge time.

4. The battery manager of claim 1, wherein the configurable resistor bank includes one or more single pole, single throw electrical contacts.

5. The battery manager of claim 1, wherein the configurable resistor bank includes one or more single pole, double throw electrical contacts.

6. The battery manager of claim 1, wherein the controller, to select the first resistance value, is configured to:
select the first resistance value, from the set of resistance values, based on the first resistance value being associated with the first voltage.

7. The battery manager of claim 1, wherein the controller, to select the first resistance value, is configured to:
select the first resistance value, from the set of resistance values, to cause a duration of the first discharge operation to be substantially the battery pack discharge time.

8. A method performed by a battery manager, comprising:
identifying a first voltage rating of a first battery pack;
configuring, based on the first voltage rating, a resistor bank of the battery manager to have a first resistance value;
performing, via the resistor bank configured to have the first resistance value, a first discharge operation associated with the first battery pack, the first discharge operation having a first duration;
identifying a second voltage rating of a second battery pack;
configuring, based on the second voltage rating, the resistor bank of the battery manager to have a second resistance value; and
performing, via the resistor bank configured to have the second resistance value, a second discharge operation associated with the second battery pack, the second discharge operation having a second duration, and a difference between the first duration and the second duration satisfying a time threshold.

9. The method of claim 8, wherein the resistor bank is capable of being configured to have multiple resistance values including the first resistance value and the second resistance value.

10. The method of claim 9, wherein a mapping defines resistance values, from the multiple resistance values, associated with respective voltage ratings, and the method further comprising:
selecting the first resistance value to be associated with the first discharge operation based on the first voltage rating and the mapping; and
selecting the second resistance value to be associated with the second discharge operation based on the second voltage rating and the mapping.

11. The method of claim 8, wherein the first discharge operation and the second discharge operation are associated with maintaining states of charge of respective battery packs from the first battery pack and the second battery pack.

12. The method of claim 8, wherein the first discharge operation is associated with using a first set of one or more resistors from the resistor bank, and
wherein the second discharge operation is associated with using a second set of one or more resistors from the resistor bank.

13. The method of claim 8, wherein the first discharge operation and the second discharge operation are associated with discharging the first battery pack and the second battery pack, respectively, a same amount with respect to a state of charge of the first battery pack and the second battery pack.

14. The method of claim 8, wherein identifying the first voltage rating of the first battery pack comprises:
obtaining, from a first controller of the first battery pack, an indication of the first voltage rating; and
wherein identifying the second voltage rating of the second battery pack comprises:
obtaining, from a second controller of the second battery pack, an indication of the second voltage rating.

15. A battery manager, comprising:
a resistor bank including a set of resistors and one or more electrical contacts, the resistor bank being configurable to have multiple resistance values;
one or more memories; and
one or more processors configured to:
identify a first voltage rating of a first battery pack that is electrically connected to the battery manager;
cause, based on the first voltage rating, the one or more electrical contacts to be configured to cause the resistor bank to have a first resistance value;
perform, via the resistor bank configured to have the first resistance value, a first discharge operation to discharge the first battery pack to a state of charge (SoC), the first discharge operation having a first duration;
identify a second voltage rating of a second battery pack that is electrically connected to the battery manager;
cause, based on the second voltage rating, the one or more electrical contacts to be configured to cause the resistor bank to have a second resistance value; and
perform, via the resistor bank configured to have the second resistance value, a second discharge operation to discharge the second battery pack to the SoC, the second discharge operation having a second duration, and a difference between the first duration and the second duration satisfying a time threshold.

16. The battery manager of claim 15, wherein the one or more processors are further configured to:
select the first resistance value to be associated with the first discharge operation based on the first voltage rating of the first battery pack; and
select the second resistance value to be associated with the second discharge operation based on the second voltage rating of the second battery pack.

17. The battery manager of claim 16, wherein a mapping of resistance values, from the multiple resistance values to respective voltage ratings, is stored in the one or more memories;
wherein the one or more processors, to select the first resistance value, are configured to:
select the first resistance value using the mapping and the first voltage rating; and
wherein the one or more processors, to select the second resistance value, are configured to:
select the first resistance value using the mapping and the second voltage rating.

18. The battery manager of claim 15, wherein the one or more electrical contacts include at least one of one or more single pole, single throw electrical contacts or one or more single pole, double throw electrical contacts.

19. The battery manager of claim 15, wherein the one or more processors, to identify the first voltage rating, are configured to:
obtain a first operator input indicating the first voltage rating; and
wherein the one or more processors, to identify the second voltage rating, are configured to:
obtain a second operator input indicating the second voltage rating.

20. The battery manager of claim 15, wherein the one or more processors, to identify the first voltage rating, are configured to:
measure the first battery pack to identify the first voltage rating; and
wherein the one or more processors, to identify the second voltage rating, are configured to:
measure the second battery pack to identify the second voltage rating.
